(19) United States
(12) Patent Application Publication
(10) Pub. No.: US 2023/0312189 A1
(43) Pub. Date: Oct. 5, 2023

(54) CONTENTS CONTAINER

(71) Applicant: YONWOO CO., LTD., Incheon (KR)

(72) Inventor: Hyo Sun JUNG, Incheon (KR)

(21) Appl. No.: 18/023,479

(22) PCT Filed: Jul. 6, 2021
(86) PCT No.: PCT/KR2021/008574

§ 371 Date: Feb. 27, 2023

(30) Foreign Application Priority Data
Aug. 26, 2020 (KR) 10-2020-0107584

(51) Int. Cl. B65D 43/20; B65D 43/22; B65D 43/24; B65D 51/18; B65D 83/00

(52) U.S. Cl. CPC B65D 43/20; B65D 43/22; B65D 43/24; B65D 51/18; B65D 83/00; B65D 2543/00092; B65D 2543/00574

(57) ABSTRACT

A container includes: a container part adapted to store a material therein and having a discharge part disposed on one side thereof to discharge the material therefrom; and a sliding cap coupled to top of the container part and moving a space between a first position for blocking the discharge part from the outside and a second position for exposing the discharge part to the outside according to external forces applied in different directions, wherein the container part and the sliding cap each have at least one or more magnetic members adapted to fix the sliding cap to the first position or the second position and help the sliding cap move, if the external force greater than a given level is applied to the sliding cap, in a direction to which the external force is applied.

### TECHNICAL FIELD

The present invention relates to a container, and more specifically, to a container that is capable of having a sliding cap whose movement is assisted by an attractive force between magnetic members.

### BACKGROUND ART

A conventional container is configured to discharge a material stored therein by a fixed amount through a discharge member such as an airless pump, and when the material is being not used for a while, air, foreign matters, and the like are prevented from entering the container, so that the material stored in the container is prevented from deteriorating in quality, thereby ensuring the long-term storage thereof.

However, in the case of the conventional container, when the material is being not used for a while, a cap has to be additionally attached to the container to perform safe storage and prevent quality deterioration of the material, and if it is desired to use the material again, the cap has to be detached from the container to operate the pump, so using the container is inconvenient and there is a risk that the cap may be lost.

To solve such problems, a container having a sliding cap coupled to the top thereof has been provided to open and close the container. However, if the sliding cap has a weak fixing force, the container is easily opened and closed by an external force, so that even if a material stored in the container is not used, the material may be discharged or contaminated, and contrarily, if the sliding cap has a strong fixing force, an excessively strong force by a user is needed to open the sliding cap.

Accordingly, there is a need to develop a new cosmetic container capable of solving such problems.

### DISCLOSURE

### Technical Problem

Accordingly, the present invention has been made in view of the above-mentioned problems occurring in the related art, and it is an object of the present invention to provide a container that is capable of having a sliding cap whose movement is assisted by an attractive force between magnetic members.

The technical problems to be achieved through the present invention are not limited as mentioned above, and other technical problems not mentioned herein will be obviously understood by one of ordinary skill in the art through the following description.

### Technical Solution

To accomplish the above-mentioned objects, according to the present invention, a container may include: a container part adapted to store a material therein and having a discharge part disposed on one side thereof to discharge the material therefrom; and a sliding cap coupled to top of the container part and moving a space between a first position for blocking the discharge part from the outside and a second position for exposing the discharge part to the outside according to external forces applied in different directions, wherein the container part and the sliding cap each have at least one or more magnetic members adapted to fix the sliding cap to the first position or the second position and help the sliding cap move, if the external force greater than a predetermined level is applied to the sliding cap, in a direction to which the external force is applied.

Desirably, the magnetic members may include: first and second magnetic members disposed spaced apart from each other on one of the container part and the sliding cap; and a third magnetic member disposed on the other of the container part and the sliding cap, and the third magnetic member is aligned with the first magnetic member at the first position and with the second magnetic member at the second position.

Further, desirably, the magnetic members may help the sliding cap move to the first position or the second position according to relative changes in an attractive force between the first magnetic member and the third magnetic member and an attractive force between the second magnetic member and the third magnetic member.

Further, desirably, if the sliding cap moves by a predetermined distance toward the second position from the first position by means of the external force, the sliding cap may move to the second position by means of the attractive force between the second magnetic member and the third magnetic member, and if the sliding cap moves by a predetermined distance toward the first position from the second position by means of the external force, the sliding cap may move to the first position by means of the attractive force between the first magnetic member and the third magnetic member.

Further, desirably, the container part may include: an inner container having a storage space formed therein to store the material therein; a pump coupled to top of the inner container to discharge the material stored in the storage space to the discharge part; and an outer container coupled to the outer peripheral surface of the inner container and having the discharge part disposed on one side of top thereof and communicating with the pump, the magnetic members being disposed on top of the outer container to help the sliding cap move.

Further, desirably, the outer container may include: a connector adapted to connect the discharge part to the pump so that the material discharged from the pump is transferred to the discharge part; and an accommodation portion concavely formed on one area of top thereof to accommodate the material discharged from the discharge part therein.

Further, desirably, the inner container may be sealedly closed as the pump is coupled to top thereof, and an inner container assembly as the inner container to which the pump is coupled may be coupled to and separated from the outer container.

Further, desirably, if the sliding cap or the outer container is pressurized downward at the second position, the material may be discharged to the discharge part.

Further, desirably, the outer container may include at least one or more coupling slots having a predetermined length formed on top thereof, and the sliding cap may include at least one or more sliding coupling members extending downward from the underside thereof and thus inserted into the coupling slots, so that if the external force is applied to the sliding cap, the sliding coupling members move along the coupling slots to guide the moving direction of the sliding cap.

Further, desirably, the inner container may have locking projections protruding upward from top thereof, so that the ends of the sliding coupling members are aligned with tops of the locking projections at the first position to thus prevent the sliding cap from moving downward.

Further, desirably, the inner container may have fitting projections protruding from top thereof, and the outer container may have fixing members disposed therein, the fixing members having fitting slots with the corresponding shapes to the fitting projections, so that if the inner container is inserted into the outer container, the fitting projections are fitted to the fitting slots to thus allow the sliding coupling members to be aligned with given positions at a top portion of the inner container.

### Advantageous Effects

According to the present invention, the sliding cap moves the space between the first position for blocking the discharge part and the second position for exposing the discharge part to the outside, so that if the material is not used, the discharge part is blocked from the outside and thus prevented from being contaminated.

According to the present invention, further, the container part and the sliding cap have the magnetic members adapted to fix the sliding cap to the first position or the second position and, if the external force greater than the predetermined level is applied to the sliding cap, help the sliding cap move to the second position or the first position.

According to the present invention, further, the outer container and the inner container are detachably coupled to each other, so that if the material is all consumed, the inner container may be replaced by a new inner container.

According to the present invention, further, the pump is prevented from operating at the first position for blocking the discharge part by the sliding cap, so that if the material is not used or when the inner container is replaced with the new inner container, the material is prevented from being discharged unintentionally.

### BRIEF DESCRIPTION OF DRAWINGS

To allow sufficient understanding of the drawings mentioned in the description of the present invention, a brief description of the drawings is provided.

FIG. 1 is an elevation view showing a container according to the present invention.

FIG. 2 is a sectional view showing the container according to the present invention.

FIG. 3 is an exploded perspective view showing the container according to the present invention.

FIG. 4 is an exploded sectional view showing the container according to the present invention.

FIG. 5 is a perspective view showing a sliding cap of the container according to the present invention.

FIG. 6 is an exploded perspective view showing a coupling relation among an inner container assembly, an outer container, and the sliding cap according to the present invention.

FIGS. 7A and 7B are perspective and sectional views showing exemplary operations of the container according to the present invention.

FIG. 8 is a sectional view showing exemplary operations of the container according to the present invention.

### MODE FOR INVENTION

Hereinafter, example embodiments will be described with reference to the accompanying drawings. However, for reference numerals, with respect to the same elements, even though they may be displayed in different drawings, such elements use same reference numerals as much as possible. Also, in explaining the example embodiments, detailed description on known elements or functions will be omitted if it is determined that such description will interfere with understanding of the embodiments. In addition, the example embodiments may be embodied in different forms and should not be construed as limited to the embodiments set forth herein but may be modified and variously implemented by those skilled in the art. Further, top, bottom, left and right directions as will be described below are determined with reference to the drawings, and accordingly, the scope of the present invention is not necessarily restricted to the corresponding directions.

In the description, when it is said that one element is described as being “connected” to the other element, one element may be directly connected or coupled to the other element, but it should be understood that another element may be present between the two elements. When it is said that one portion is described as “includes” any component, further, one element may further include other components unless no specific description is suggested. Also, in explaining elements, terms like “first”, “second”, “A”, “B”, “(a)”, “(b)”, etc. may be used. However, such terms are used to distinguish one from the others only and they do not affect the essence, nature, sequence, order, etc.

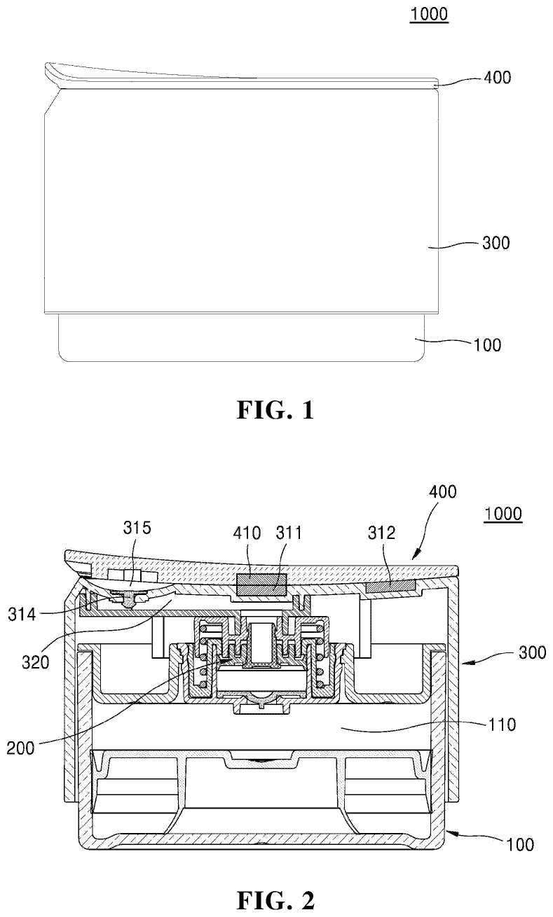

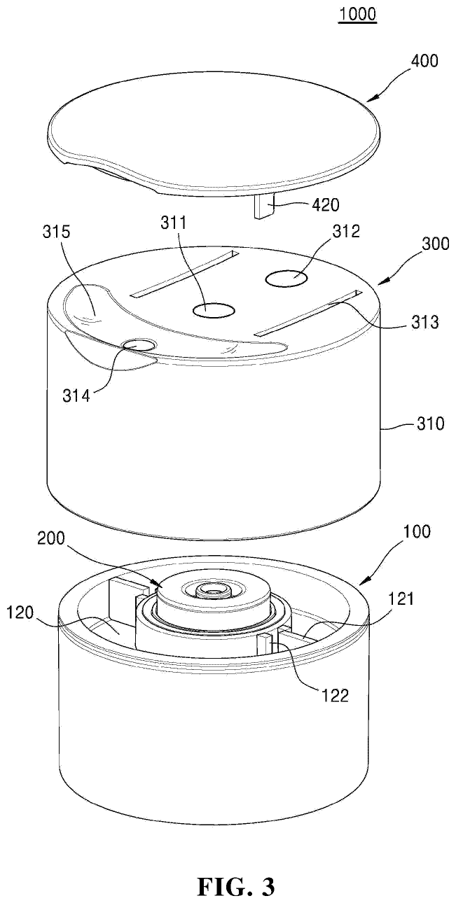

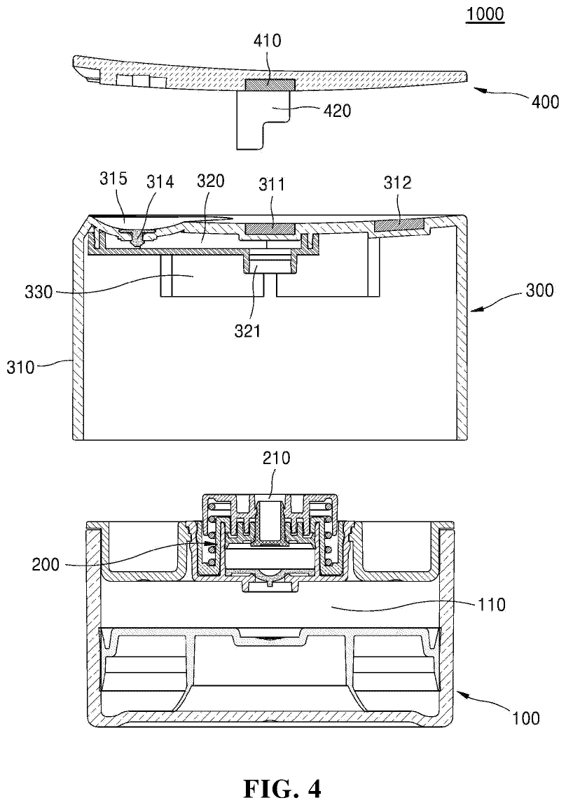

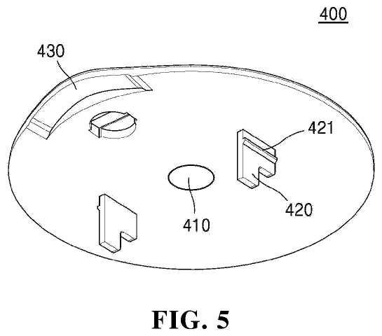

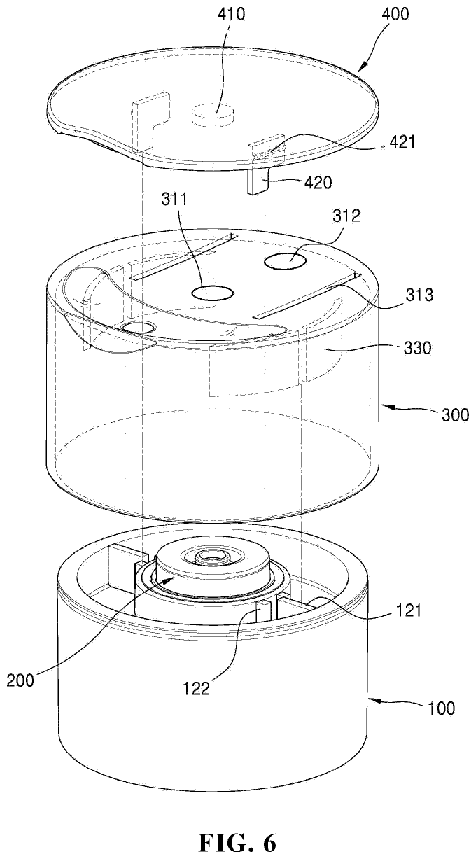

FIG. 1 is a perspective view showing a container according to the present invention, FIG. 2 is a sectional view showing the container according to the present invention, FIG. 3 is an exploded perspective view showing the container according to the present invention, FIG. 4 is an exploded sectional view showing the container according to the present invention, and FIG. 5 is a perspective view showing a sliding cap of the container according to the present invention.

Referring to FIGS. 1 to 5, a container 1000 according to the present invention includes container parts 100, 200, and 300 and a sliding cap 400.

The container parts 100, 200, and 300 serve to store a material therein and discharge the material to the outside. To do this, a discharge part 314 is disposed on one side of the container parts 100, 200, and 300 and communicates with the interiors of the container parts 100, 200, and 300. The discharge part 314 is blocked from the outside or exposed to the outside according to the movements of the sliding cap 400 in position and thus serves to discharge the material to the outside if the top of the sliding cap 400 and/or the outer container 300 is pressurized by a user. In this case, the material includes a cosmetic, a medicine, and a quasi-drug like tooth paste, but it is just exemplary, so that the material may include all kinds of materials capable of being discharged by means of pumping.

According to the present invention, the container parts 100, 200, and 300 represent the inner container 100, the pump 200, and the outer container 300.

The inner container 100 includes a storage space 110 formed therein to store the material therein and an inner container cap 120 for sealing a portion of the top of the storage space 110. The inner container cap 120 is coupled to the pump 200 to sealedly close the storage space 110, which will be described later.

Further, fitting projections 121 and locking projections 122 protrude from a top of the inner container 100 (particularly, the top of the inner container cap 120). The fitting projections 121 serve to couple the inner container 100 to the outer container 300 to a predetermined angle, and the locking projections 122 serve to prevent the sliding cap 400 from moving downward. The operations will be explained in detail later.

According to the present invention, the inner container 100 further includes a disc disposed inside the storage space 110 so that it moves upward whenever the material is discharged. The disc serves to push the material upward as the material stored in the storage space 110 becomes consumed, and in specific, the disc is kept to come into close contact with the inner peripheral wall of the storage space 110, so that as the material is discharged to decrease in volume in the storage space 110, the disc moves up.

The pump 200 is coupled to the top of the inner container 100 and thus discharges the material stored in the storage space 110 to the outer container 300 when pressurized. For example, the pump 200 includes a cylinder having an inlet communicating with the interior of the storage space 110, a seal cap disposed at the inner peripheral wall of the cylinder, a sealing member coupled to the top end periphery of the cylinder to suppress the seal cap from rising, a piston rod having an inlet formed on one end thereof and open and closed by means of the seal cap, a stem coupled and elevated unitarily with the piston rod and connected to the outer container 300, and an elastic member for providing an elastic force in a direction toward the outer container 300 from the sealing member. However, such a configuration of the pump 200 may be not limited thereto.

Further, a discharge part 210 is located on top of the pump 200 (that is, the top of the stem) to discharge the material according to the pumping operation of the pump 200. The discharge part 210 is detachably connected to a connector 320 of the outer container 300 to thus transfer the material discharged from the discharge part 210 to the discharge part 314.

The inner container 100 is sealedly closed as the pump 200 is coupled to the top thereof. For example, the inner container 100 is configured to allow the inner container cap 120 having a hollow portion formed therein to be coupled to the top of the storage space 110, while the pump 200 is being coupled to the hollow portion of the inner container cap 120. The hollow portion of the inner container cap 120 corresponds to the shape of the pump 200, so that when the pump 200 is coupled to the inner container cap 120, the perfect sealing of the inner container cap 120 can be achieved. The inner container cap 120 and the pump 200 are coupled to each other by means of screw coupling or fitting, but they may be coupled to each other by means of various methods only if the sealing is achieved, without being limited thereto.

The outer container 300 is coupled to the outer peripheral surface of the inner container 100 to surround the inner container 100 and has the discharge part 314 disposed on one side of a top thereof and communicating with the pump 200. For example, the outer container 300 is open on underside thereof, and as the inner container assembly as the inner container 100 and the pump 200 coupled to each other is inserted into the open underside of the outer container 300, the outer container 300 is detachably coupled to the inner container assembly. The discharge part 314 includes an ejecting hole (having no reference numeral) and a stopper (having no reference numeral) for sealing the ejecting hole, and if the sliding cap 400 and/or the outer container 300 is pressurized by the user, at least a portion of the stopper is spaced apart from the ejecting hole by means of the ejection pressure of the material, so that the material is discharged to the outside.

The outer container 300 has at least one or more coupling slots 313 having a predetermined length formed on the top thereof. In this case, sliding coupling members 420 of the sliding cap 400 are inserted into the coupling slots 313 to thus move the sliding cap 400 to a direction.

Further, the outer container 300 includes an accommodation portion 315 concavely formed on one area of the top thereof to accommodate the material discharged from the discharge part 314 therein and the connector 320 adapted to connect the discharge part 314 to the pump 200 so that the material discharged from the pump 200 is transferred to the discharge part 314. If the material stored in the inner container 100 is discharged by means of the pump 200, the material is transferred to the discharge part 314 by means of the connector 320, and if the material discharged from the discharge part 314 is accommodated in the accommodation portion 315, it is applied to the user's skin.

The connector 320 has a coupling hole 321 formed on the underside thereof. As a result, at least a portion of the discharge part 210 located on top of the pump 200 is coupledly fitted to the coupling hole 321, and when the pump 200 is pressurized, the material discharged from the pump 200 is transferred to the connector 320 and the discharge part 314 sequentially. To allow the discharge part 210 to be fitted to the coupling hole 321, a fitting protrusion and/or a fitting groove may be formed on the outer peripheral surface of the discharge part 210 and the inner peripheral surface of the coupling hole 321, but they are just exemplary. Therefore, various structures may be provided to perform their detachable coupling.

The outer container 300 includes fixing members 330 having fitting slots (having no reference numeral) with the corresponding shapes to the fitting projections 121 of the inner container 100. If the inner container 100 is inserted into the outer container 300 to perform the coupling therebetween, the fitting projections 121 are fitted to the fitting slots of the fixing members 330 by the user, so that the inner container 100 and the outer container 300 can be coupled to each other to a predetermined angle. The depths of the fitting slots are greater than the heights of the fitting projections 212, so that the outer container 300 can move downward.

According to the present invention, the inner container 100 can be coupled to and separated from the outer container 300 to the form of the inner container assembly as the inner container 100 to which the pump 200 is coupled. As a result, if the material stored in the inner container 100 is all consumed, the inner container assembly is separated from the outer container 300, and next, the inner container assembly in which a new material is accommodated is coupled to the outer container 300, thereby performing the refill of the material with ease.

The sliding cap 400 is coupled to the tops of the container parts 100, 200, and 300 and moves horizontally to block and expose the discharge part 314 from and to the outside. For example, the sliding cap 400 is coupled to the top of the outer container 300 and moves a space between a first position for blocking the discharge part 314 from the outside and a second position for exposing the discharge part 314 to the outside according to external forces applied in different directions. To use the material stored in the inner container 100, the sliding cap 400 moves to the second position by the user to expose the discharge part 314 to the outside, and if the material is not used, the sliding cap 400 moves to the first position by the user to block the discharge part 314 from the outside so that the discharge part 314 and the accommodation portion 315 can be protected from contamination.

Further, at least one or more magnetic members 311, 312, and 410 are disposed on the container parts 100, 200, and 300 and the sliding cap 400 to help the sliding cap 400 move.

The magnetic members 311, 312, and 410 represent the first magnetic member 311, the second magnetic member 312, and the third magnetic member 410. For example, the first magnetic member 311 and the second magnetic member 312 are disposed spaced apart from each other on one of the outer container 300 and the sliding cap 400, and the third magnetic member 410 is disposed on the other.

According to the present invention, the first magnetic member 311 and the second magnetic member 312 are disposed spaced apart from each other on top of the outer container 300, and the third magnetic member 410 is disposed on the underside of the sliding cap 400. In specific, the first magnetic member 311 is disposed on the center of the top of the outer container 300, the second magnetic member 312 is spaced apart from the first magnetic member 311 in a horizontal direction, and the third magnetic member 410 is disposed on the center of the underside of the sliding cap 400. In this case, the discharge part 314 and the accommodation portion 315 are located on the opposite side to the second magnetic member 312. However, such a configuration is just exemplary, and therefore, the number of magnetic members 311, 312, and 410 and the positions of the magnetic members 311, 312, and 410, the discharge part 314, and the accommodation portion 315 may be freely changed according to embodiments of the present invention, without being limited thereto.

The magnetic members 311, 312, and 410 serve to fix the sliding cap 400 to the first position or the second position, and if an external force greater than a predetermined level is applied to the sliding cap 400, they help the sliding cap 400 move to the first position or the second position.

For example, at the first position the third magnetic member 410 is aligned with the first magnetic member 311, so that by means of an attractive force between the third magnetic member 410 and the first magnetic member 311, the sliding cap 400 is fixed to the first position. Contrarily, at the second position the third magnetic member 410 is aligned with the second magnetic member 312, so that by means of an attractive force between the third magnetic member 410 and the second magnetic member 312, the sliding cap 400 is fixed to the second position. Further, if the external force greater than the predetermined level is applied to the sliding cap 400 to allow the sliding cap 400 to move toward the first position or the second position, the attractive force between the third magnetic member 410 and the first magnetic member 311 and the attractive force between the third magnetic member 410 and the second magnetic member 312 are relatively changed with each other, so that by means of the changes in the attractive forces, the magnetic members 311, 312, and 410 help the sliding cap 400 move to the first position or the second position.

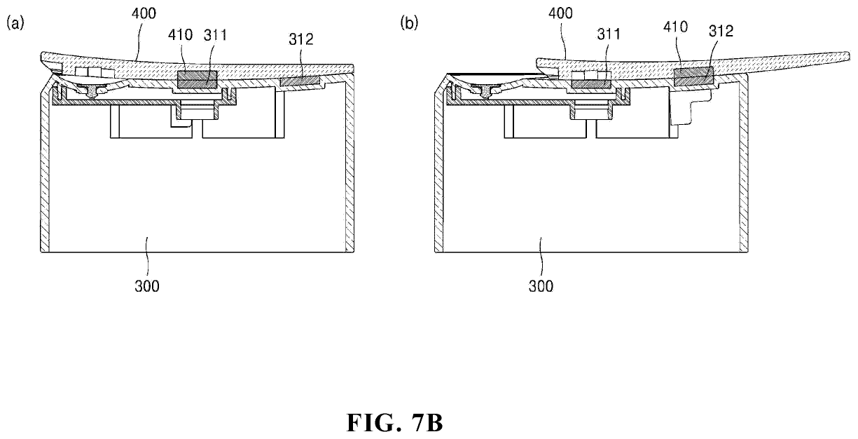

The operations of the sliding cap 400 will be explained in detail later with reference to FIGS. 7A and 7B.

The magnetic members 311, 312, and 410 may be formed of, for example, samarium magnets, scandium magnets, yttrium magnets, neodymium magnets, superconductive electromagnets, or the like, but they may be formed of various materials only if they generate a magnetic force, without being limited thereto.

According to the present invention, the sliding cap 400 includes at least one or more sliding coupling members 420 extending downward from the underside thereof and thus inserted into the coupling slots 313. If the external force is applied to the sliding cap 400, the sliding coupling members 420 move along the coupling slots 313 to guide the moving direction of the sliding cap 400. For example, the sliding coupling members 420 are disposed on both sides of the third magnetic member 410, and correspondingly to the sliding coupling members 420, the coupling slots 313 are formed on both sides of the first magnetic member 311 and the second magnetic member 312 and extend to the predetermined length so that the sliding cap 400 is movable to the first position and the second position. However, such a configuration is just exemplary, and only one sliding coupling member 420 and one coupling slot 313 may be provided, without being limited thereto.

According to the present invention, each sliding coupling member 420 has at least one locking protrusion 421 formed on the side surface thereof. If the sliding coupling members 420 are inserted into the coupling slots 313, the locking protrusions 421 are locked onto the underside edges of the coupling slots 313 to prevent the sliding cap 400 from escaping upward, thereby preventing the sliding cap 400 from being arbitrarily separated from the outer container 300.

According to the present invention, the sliding cap 400 has a handle portion 430 protruding upward from a portion of the side periphery thereof, and the outer container 300 has an inclined surface formed on the side of the top thereof at the corresponding position to the handle portion 430.

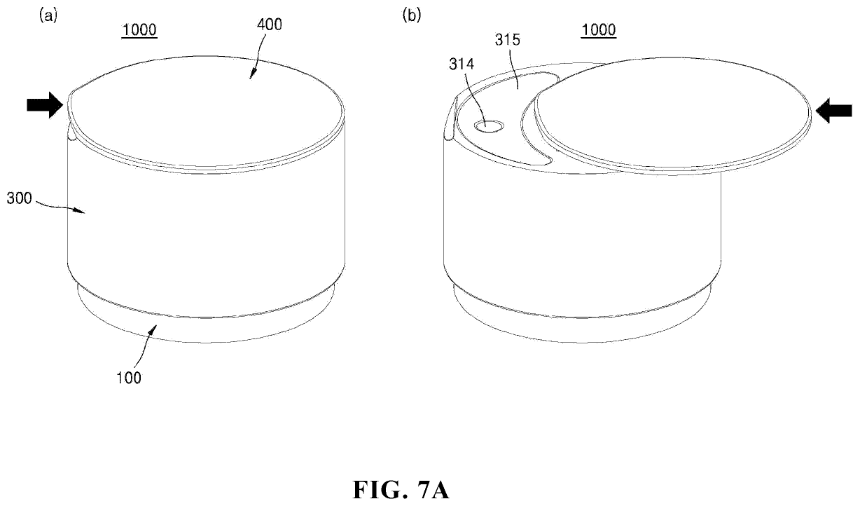

FIG. 6 is an exploded perspective view showing a coupling relation among the inner container assembly, the outer container, and the sliding cap according to the present invention.

Referring to FIG. 6, as the inner container assembly, the outer container 300, and the sliding cap 400 are coupled to one another, the magnetic members 311, 312, and 410, the locking projections 122, the coupling slots 313 and/or the sliding coupling members 420 are aligned with one another at given positions.

First, if the sliding coupling members 420 are inserted into the coupling slots 313 of the outer container 300, the sliding cap 400 is coupled to the outer container 300 by means of the locking protrusions 421. In this case, at least portions of the sliding coupling members 420 protrude inward from the outer container 300, and if the sliding cap 400 moves to allow the third magnetic member 410 to be aligned with the first magnetic member 311, the sliding cap 400 is fixed to the first position for completely blocking the discharge part 314 from the outside, while the sliding coupling members 420 are being aligned with the ends of the coupling slots 313 toward the first magnetic member 311.

Next, the inner container assembly is inserted into the open underside of the outer container 300, and if the fitting projections 121 are fitted to the fitting slots of the fixing members 330, the inner container 100 and the outer container 300 are coupled to each other to the predetermined angle. In this case, the locking projections 122 formed on top of the inner container 100 are aligned with the ends of the coupling slots 313 toward the first magnetic member 311, and accordingly, if the sliding cap 400 is fixed to the first position, the locking projections 122 are aligned with the ends of the sliding coupling members 420.

Accordingly, the container 1000 according to the present invention is configured to prevent the material from being discharged to the outside while the container 1000 is being carried with the user or in a process of separating the inner container 100 to refill the inner container 100 with a new material. That is, the locking projections 122 and the sliding coupling members 420 are aligned with one another at the first position where the discharge part 314 is blocked from the outside, and accordingly, even if the sliding cap 400 is pressurized downward, it cannot move downward, so that the material is prevented from being discharged owing to the unintentional operation of the pump 200.

FIGS. 7A and 7B are perspective and sectional views showing exemplary operations of the container according to the present invention.

In FIG. 7B, only the sliding cap 400 and the outer container 300 are shown for the conveniences of the description, but the inner container 100 and the pump 200 may be further included.

Referring to FIGS. 7A and 7B, the sliding cap 400 blocks the discharge part 314 and the accommodation portion 315 at the initial first position. At the first position, the third magnetic member 410 is aligned with the first magnetic member 311, so that by means of the attractive force between them, the sliding cap 400 is kept to the state of blocking the discharge part 314. Further, the sliding coupling members 420 of the sliding cap 400 are aligned with the tops of the locking projections 122, so that the sliding cap 400 is kept to the state of preventing the downward movement thereof.

If the external force greater than the predetermined level toward the second position is applied to the sliding cap 400 (particularly, the handle portion 430) by the user, the sliding cap 400 moves horizontally from the first position to the second position. If the sliding cap 400 moves by a predetermined distance, the attractive force between the third magnetic member 410 and the second magnetic member 312 is stronger than that between the third magnetic member 410 and the first magnetic member 311, and accordingly, even if the external force is not applied anymore by the user, the sliding cap 400 moves to the second position by means of the attractive force between the third magnetic member 410 and the second magnetic member 312. In this case, at the second position the third magnetic member 410 is aligned with the second magnetic member 312, so that by means of the attractive force between them, the sliding cap 400 is kept to the state of allowing the discharge part 314 and the accommodation portion 315 to be completely exposed to the outside, and the tops of the sliding cap 400 and/or the outer container 300 are pressurized downward by the user to discharge the material to the outside.

Next, if the external force greater than the predetermined level toward the opposite direction (that is, the first position) to the second position is applied to the sliding cap 400 by the user, the sliding cap 400 moves horizontally from the second position to the first position. If the sliding cap 400 moves by a predetermined distance, the attractive force between the third magnetic member 410 and the first magnetic member 311 is stronger than that between the third magnetic member 410 and the second magnetic member 312, and accordingly, even if the external force is not applied anymore by the user, the sliding cap 400 moves to the first position by means of the attractive force between the third magnetic member 410 and the first magnetic member 311 to thus block the discharge part 314 and the accommodation portion 315 again from the outside.

As shown in FIGS. 1 to 7B, only the embodiment wherein the first magnetic member 311 and the second magnetic member 312 are disposed on the outer container 300, and the third magnetic member 410 on the sliding cap 400 has been provided, but various embodiments wherein the sliding cap 400 moves with the help of the magnetic members may be provided, without being limited thereto. For example, the first magnetic member 311 and the second magnetic member 312 may be disposed on the sliding cap 400, and the third magnetic member 410 on the outer container 300. Further, a fourth magnetic member may be disposed on the sliding cap 400.

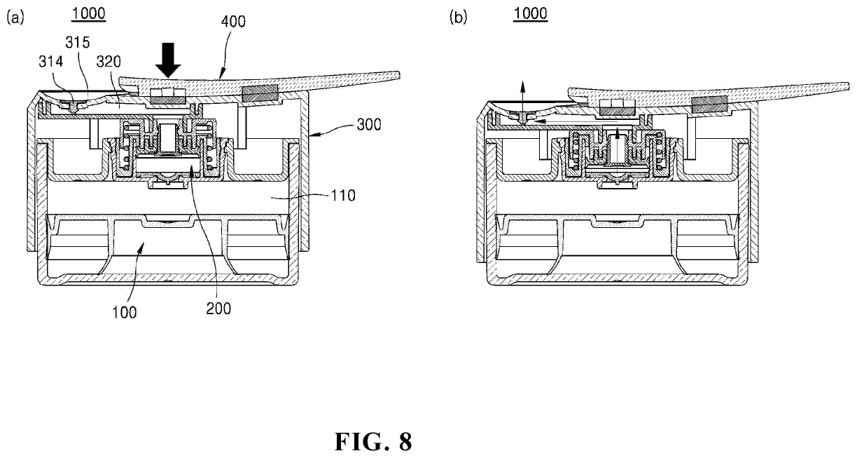

FIG. 8 is a sectional view showing exemplary operations of the container according to the present invention.

Referring to FIG. 8, the sliding cap 400 moves to the second position by the user to expose the discharge part 314 to the outside, and next, the tops of the sliding cap 400 and/or the outer container 300 are pressurized downward by the user to discharge the material to the outside. For example, if the sliding cap 400 is pressurized downward at the second position, the sliding cap 400 and the outer container 300 move down to operate the pump 200. Accordingly, the material is discharged to the discharge part 210, and the discharged material moves to the discharge part 314 through the connector 320 and is then discharged.

After the material has been used, next, the sliding cap 400 moves to the first position by the user to thus block the discharge part 314 and the accommodation portion 315. As a result, the discharge part 314 and the accommodation portion 315 are prevented from being contaminated. Further, as mentioned above, the locking projections 122 serve to prevent the material from being discharged by the downward pressurization of the sliding cap 400 at the first position, thereby secondarily preventing the container 1000 from being contaminated.

As mentioned above, the preferred embodiment of the present invention has been disclosed in the specification and drawings. In the description of the present invention, special terms are used not to limit the present invention and the scope of the present invention as defined in claims, but just to explain the present invention. Therefore, persons skilled in the relevant art can appreciate that many modifications and variations are possible in light of the above teachings. It is therefore intended that the scope of the invention be limited not by this detailed description, but rather by the claims appended hereto.

1. A container comprising:
a container part configured to store a material therein and having a discharge part disposed on one side thereof to discharge the material therefrom; and
a sliding cap coupled to a top of the container part and configured to move between a first position for blocking the discharge part from an outside and a second position for exposing the discharge part to the outside according to external forces applied in different directions,
wherein the container part and the sliding cap each have at least one or more magnetic members configured to fix the sliding cap to the first position or the second position and to help move the sliding cap when an external force greater than a predetermined amount is applied to the sliding cap in a direction to which the external force is applied.

2. The container according to claim 1, wherein the at least one or more magnetic members comprise:
a first magnetic member and a second magnetic member disposed spaced apart from each other on either one of the container part or the sliding cap; and
a third magnetic member disposed on the other of the container part or the sliding cap on which the first and the second magnetic members are disposed, and
wherein the third magnetic member is aligned with the first magnetic member at the first position and is aligned with the second magnetic member at the second position.

3. The container according to claim 2, wherein the at least one or more magnetic members help move the sliding cap to the first position and the second position according to relative changes in an attractive force between the first magnetic member and the third magnetic member and an attractive force between the second magnetic member and the third magnetic member, respectively.

4. The container according to claim 2, wherein when the sliding cap moves by a predetermined distance toward the second position from the first position by means of the external force, the sliding cap moves to the second position by means of an attractive force between the second magnetic member and the third magnetic member, and when the sliding cap moves by the predetermined distance toward the first position from the second position by means of the external force, the sliding cap moves to the first position by means of the attractive force between the first magnetic member and the third magnetic member.

5. The container according to claim 1, wherein the container part comprises:
an inner container having a storage space formed therein to store the material therein;
a pump coupled to a top of the inner container and configured to discharge the material stored in the storage space to the discharge part; and
an outer container coupled to an outer peripheral surface of the inner container and having the discharge part disposed on one side of a top thereof and communicating with the pump,
wherein the at least one or more magnetic members are disposed on the top of the outer container to help move the sliding cap.

6. The container according to claim 5, wherein the outer container comprises:
a connector configured to connect the discharge part to the pump and the material discharged from the pump is transferred to the discharge part through the connector; and
an accommodation portion concavely formed on one area of the top of the outer container and configured to accommodate therein the material discharged from the discharge part.

7. The container according to claim 5, wherein the pump is sealedly coupled to the top of the inner container, and
wherein the inner container and the pump which are sealedly coupled to each other form an inner container assembly, and the inner container assembly is detachably coupled to the outer container.

8. The container according to claim 5, wherein when the sliding cap or the outer container is pressurized downward at the second position, the material is discharged to the discharge part.

9. The container according to claim 5, wherein the outer container comprises at least one or more coupling slots formed on the top thereof and each having a predetermined length, and
wherein the sliding cap comprises at least one or more sliding coupling members extending downward from an underside thereof and inserted into corresponding at least one or more coupling slots, and when the external force is applied to the sliding cap, the at least one or more sliding coupling members move along the corresponding at least one or more coupling slots to guide the moving of the sliding cap.

10. The container according to claim 9, wherein the inner container has at least one or more locking projections protruding upward from the top thereof, and ends of the at least one or more sliding coupling members are aligned with tops of corresponding at least one or more locking projections at the first position and the at least one or more locking projections prevent the sliding cap from moving downward.

11. The container according to claim 9, wherein the inner container comprises at least one or more fitting projections protruding from the top thereof, and the outer container has at least one or more fixing members disposed therein, the at least one or more fixing members having fitting slots corresponding to a shape of the at least one or more fitting projections,
wherein when the inner container is inserted into the outer container, the at least one or more fitting projections are fitted into corresponding fitting slots of the at least one or more fixing members to allow the at least one or more sliding coupling members to be aligned with given positions at a top portion of the inner container.
